(19) United States
(12) Patent Application Publication
(10) Pub. No.: US 2015/0046438 A1
(43) Pub. Date: Feb. 12, 2015

(54) INTEGRATOR ACCOUNT SYSTEM FOR SELECTED INFORMATION AND THE VIRAL PROCESS

(71) Applicants: Ricardo SANCHEZ, Col. Jardinas De Merida (MX); Fernando ROJAS, Frac.Gonazlo Guerero (MX)

(72) Inventor: Ricardo Sanchez Marchand, Col. Jardines de Merida (MX)

(21) Appl. No.: 14/385,456

(22) PCT Filed: Mar. 15, 2013
(86) PCT No.: PCT/IB2013/000931

§ 371 Date: Sep. 15, 2014

Related U.S. Application Data
(60) Provisional application No. 61/611,846, filed on Mar. 16, 2012.

(51) Int. Cl. G06F 17/30; H04L 29/06; H04L 29/08; H04L 12/18

(52) U.S. Cl. CPC G06F 17/30424; H04L 12/1813; H04L 65/40; H04L 67/22
USPC 707/723; 707/722

(57) ABSTRACT

The disclosed subject matter is a process that can integrate specific information into a single account, in an open way, for the user. The matching process occurs based on the interest of the user, and not based on defined criteria somebody else created and forced onto the user, such as a specific company or another person's interest. The invention also has a viral process which allows the information to be available to different users very quickly and focused on the specific user's target of interest through the use of loyalty programs (or contests where permitted).

### FIELD OF INVENTION

A system able to search, classify and select information available in networks, to integrate into a single package of information, in real time and to open groups.

### BACKGROUND OF THE INVENTION

Today information that was managed through traditional media like television, radio and newspapers, is available through digital media, which enables a potentially powerful service making information accessible to the majority of people regardless of location. Consequently this generates more impact on society, allowing a person to obtain specific information related to one topic.

Unfortunately, even when the published information is classified using some criteria related to the target audience, the user has to complete an additional selection process, in some cases, multiple additional selection steps.

There are currently no open processes that can provide selected information, in a simple way, without requiring the user to register in a certain group, which usually requires personal data and information related to paying alternatives. This situation is not comfortable for the user and also is risky because of the personal data the user is required to provide.

There exist similar kinds of services today, for example US2011/0047012, but these solutions accomplish the task in a much more complicated way, and place special constraints on the matching process between the users and the suppliers of information. This is a controlled process of providing information and is closed because it requires registration.

Therefore the flow of the information between the user and the provider is not free and not open; therefore, the information of real interest to the user does not reach him or her effectively.

### BRIEF DESCRIPTION OF THE INVENTION

The disclosed subject matter is a process that can integrate specific information into a single account, in an open way, for the user. The matching process occurs based on the interest of the user, and not based on defined criteria somebody else created and forced onto the user, such as a specific company or another person's interest. The invention also has a viral process which allows the information to be available to different users very quickly and focused on the specific user's target of interest through the use of loyalty programs (or contests where permitted).

This is where the disclosed subject matter has its main application, helping the user to identify, select, and prioritize the information while integrating the information into one account, thereby enabling the user to access information pertinent to the user easily, quickly, and effectively.

In the disclosed subject matter, the concept is completely open, so the matching process, or the decision of which information the user(s) wants to see, is made by the user(s), not by the system or the company controlling the system.

An objective of the disclosed subject matter is to enable the user to select information that they want form a plurality of information sources and/or individual pieces of information, which could be displayed to the user via the screen, and then provide the information in real time or near real time.

Continuing with the open nature of the disclosed subject matter, another object of the invention is that the user can obtain information without the requirement of giving personal information, thereby creating more confidence in the system and enabling the information to flow more freely.

Another object of the disclosed subject matter is to create an open group with easy access to the information along with an effective way of distributing the information.

Yet another object of the disclosed subject matter is to provide a system that identifies RSS feeds, substitutes potentially problematic characters or words, removes potentially offending or inconsistent words or messages, identifies and classifies messages according to keywords, posts the messages either as the original poster or a different poster, and tracks the popularity of the message.

Another object of the disclosed subject matter is to classify messages based on popularity and repost more popular messages or types of messages.

Another object of the disclosed subject matter is to provide sponsors a way to configure and run a loyalty program (or contest where permitted) related to a particular offer or message and to manage and evaluate the loyalty programs (or contests where permitted).

These and other aspects of the disclosed subject matter are provided herein; however, it should not be interpreted that every single object be required, that the objects be required in a certain order, or that any particular combination of aspects be in any particular embodiment, unless specifically set forth therein.

### BRIEF DESCRIPTION OF DRAWINGS

FIGS. 1a and 1b depict two different ways of publishing a particular piece of information according to one embodiment of the disclosed subject matter.

FIGS. 2a and 2b depict exemplary reports available as part of the disclosed subject matter.

FIG. 3 depicts an exemplary flow diagram of one embodiment of the process of the disclosed subject matter.

### DESCRIPTION OF THE INVENTION

This system can search and identify selected information on a specific topic, from a wide variety of sources including the web, social media and any other information network (including private networks). Generally, the information is selected and then a classification and prioritization is completed to organize and define the priority of each package of information.

Once the information is identified, classified and prioritized, the system integrates all the information in one account so it can be displayed in an effective way. In an alternative embodiment, the information is integrated into multiple accounts. The system allows the user to assign specific criteria related to geographic area (e.g. geographic area of the user or the information) to correlate with where the information is generated in the network. This geographic feature is additional criteria that together with the identification, valuation and selection of the information, generates a package of information with real value for the user. At least some of this real value is the integration and presentation in an organized way via electronic media (e.g. a personal computer, smart phone, mobile phone, tablet, pads, or similar).

This system works in real time (or near real time), considering that the information networks, such as the Internet, intranets, web pages, MySpace® (a registered trademark of MySpace, Inc.), Facebook® (a registered trademark of Facebook, Inc.), Twitter® (a registered trademark of Twitter, Inc.), etc. is continuously changing. Also, since the search process is done on-line and with a specific period of time, it reflects the preferred trends of the users, generating an accelerated process of processing the information.

In one embodiment, the system piggy backs on the RSS (really simple syndication) format. RSS is a format that is used to share content throughout the web and provides a mechanism for automatic updating. For example: Any user can ask for an RSS to get content on Twitter®, Facebook® or Web pages.

With this in mind, the first step of the system is obtaining the information. Every site requires different ways of asking for information. Some have published instructions written in their own programming language to request an RSS feed. Regardless, the information is obtained from different sources in different ways:

For example from Twitter®: Twitter® provides an API (application programming interface) to access information contained on Twitter®. This particular interface provides different instructions to submit direct orders to Twitter® to perform a specific action.

Another possibility to locate information on Twitter® is to use the Twitter® API Geocode. Geocode works in coordination with the system to search and find users which are tweeting near the area on an average ratio. Once these users are identified, one or more of them could be selected and their information retrieved via RSS for presentation to the user.

There is one instruction used to ask Twitter to give us in a RSS feed of all the tweets of a user. In this example, this can be accomplished through the URL: twitter.com/statuses/User_timeline/userid.rss.

Continuing with this example, the system requests information from twitter with this command api.twitter.com/users/show/[your Twitter username].json.

Finally, Geocode can also be used to identify users that are tweeting near a particular geographic area and/or about a particular geographic area. This is accomplished by providing Geocode a location (e.g. coordinates) and Geocode searches and identifies users which are tweeting near the area. Once the users are identified, the Twitter® user's id's can be used to obtain their RSS feeds.

From Facebook®: The way of doing things on this site is different that the one used before. When someone gets onto a fan page, the person can get the address from the top of his/her browser. For example: www.facebook.com/Promos.Merida.

To extract the user id, one should substitute the http:// for graph.(period) in the URL. This command reveals the user id. Then, the system copies the user id and places it inside the following link: www.facebook.com/feeds/page.php?id=##USERID&format=rss20. This URL is now an RSS.

From the web: this is the conventional way of obtaining an RSS. The system can get it directly from the widgets on web pages and take them on an RSS reader of choice; this has its own URL's.

First Step: Selecting the Information Based on a Specific Criteria.

Once the system is able to identify the RSS, the criteria is defined to search and find the information that the users are interested in. This search or filtering of the RSS feed distinguishes the disclosed subject matter from a traditional RSS aggregator. One of the objectives is to obtain all the RSS feeds that the system will use to obtain the content and then filter the RSS feeds for certain predetermined information.

Second Step: Preparing the Information

After the system obtains the RSS links, the next step is to manipulate the RSS feeds. The objective is to create a “new” RSS from the information that the system obtained from other sources (e.g. make a new RSS feed that is the system's “own”).

There are two ways to manipulate the information to publish it later:

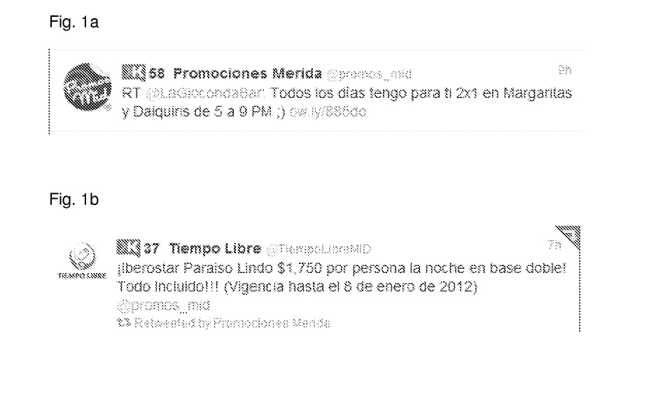

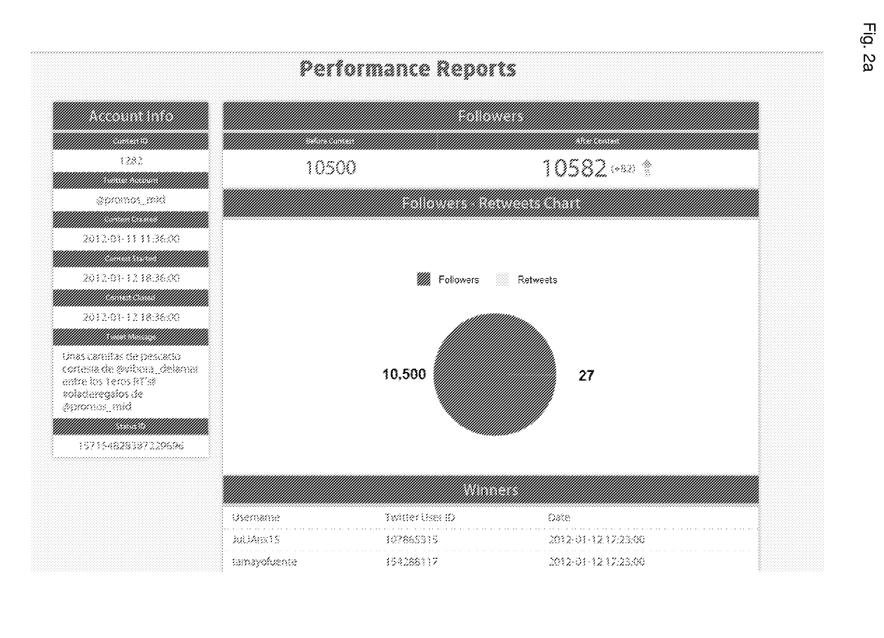

Prep 1 (FIG. 1a): The first way of manipulating the information is as follows
1. Sign up the RSS.
2. Substitute and/or modify symbols or letters to address language or other discrepancies. This way of manipulating the information is used whenever the system wants to add words or symbols throughout the obtained information (e.g. substitute “ö” with “0”).
3. Presetting filters: In this step the system identifies all the words that will not be permitted in the ready to publish RSS, so they never are published. This could be used as a “bad” word filter or to remove or identify other people's trademarks, trade names, etc. This filter would generally be pre-populated but would allow additions and deletions.
4. Choose key words to identify pertinent messages. This key word list could be prepopulated and allow for the addition and deletion of other keywords. In one embodiment, these keywords could identify sales or other offers from one or more vendors (e.g. “10% discount”, “2 for 1”, etc.).
5. In one embodiment, twitterfeed.com can be employed to publish the chosen messages. In this particular method of PREP, the chosen and edited/revised messages are posted as if the messages came from a different source (e.g. not the original source). As depicted in FIG. 1a, “Promociones Merida” is not the real original poster even though the original text appears “Todos los dias tengo para ti 2×1 en Margaritas y Daiquiris de 5 a 9 PM;)”, however, it appears that “Promociones Merida” actually produced the tweet.
6. The RSS is now ready to publish.

Prep 2 (FIG. 1b): The objective of this PREP is to re-publish the chosen and edited/revised message on the new RSS as if it was originally posted there from the original author. As a matter of clarity, the predominant difference between PREP 2 and PREP 1 is that in PREP 1: The system takes the tweets and publishes them as its own, while in PREP 2: The system retweets as if the original author tweeted, but to the new RSS. As depicted in 1b, both the original message and original “author” appear as if the posting/tweet was performed by the original author only in the new RSS.

Regardless of whether PREP 1 or PREP 2 is used, the steps remain relatively the same. Either could be automated by use of a daemon which could find, retrieve, substitute letters/words, filter against disallowed words, filter against keywords, and transmit the edited/revised message for posting/publishing.

Such an automated system could also be used to weight certain messages. In one embodiment, the weighting could dictate how often a particular message or even type of message (e.g. a discount of a particular percentage; a two for one offer for restaurants; a discount for a particular type of vendor, etc.) is republished. As a way of example, rules could be defined which dictate the identification of popular messages or types of messages and based on the rules, that message or types of messages could be republished more often than less popular messages.

For Example, one such rule could evaluate the number of times a particular message or type of message is retweeted by users such as that shown below:
RSS group 1: 0-25 Retweets→Post every 120 minutes.
RSS group 2: 25-50 Retweets→Post every 90 minutes.
RSS group 3: 50+ Retweets→Post every 30 minutes.

In this example, the system is configured to publish every so often one tweet or type of tweet. Continuing with this example, if a particular tweet was retweeted 37 times, the original tweet (regardless of whether PREP 1 or PREP 2) could be republished every 90 minutes. In an alternate example, the same type of tweet could be retweeted every 30 minutes. In these examples, the system will search for tweets that were generated during the time period and would assign a priority to those which have the higher retweet percentage. In this case, every 30 minutes you would get a post from group 3. By grouping certain tweets or types of tweets into groups the system makes a package of various tweets according to the group, so when the time for republishing comes, the system will retweet more popular messages. Although described with reference to particular times referenced with particular number of retweets, these are merely examples and other times and numbers and numbers of groups could be used interchangeably with the above.

It is important to understand that the automated tracking and grouping can be highly segmented. Not only can the system analyze and classify the type of advertisement but also what is being advertised (among a litany of other classifications: restaurant, goods, type of goods, type of restaurant, type of promotion, size of promotion, time limits on the promotion, particular stores, particular types of stores, particular geographic areas, etc.). Through this highly segmented classification, the system can group and evaluate popular posts and identify other similar posts for assigning to the same group (e.g. group 3 could hold several different “two for one” promotions within a certain city and for discount retailers (e.g. Wal-Mart® (a registered trademark of Wal-Mart Stores, Inc.), Target® (a registered trademark of Target Stores, Inc.), etc.). This creates a very powerful system that provides increased value for its users. By republishing the most popular and successful posts for those particular users (e.g. the system can manage multiple different “outgoing” RSS feeds).

The Viral Process

As part of the system, this stage includes a viral process, this means a special feature in which the information that is published by the system in the integrated account, is used to motivate the users to invite other users to access the information.

This viral process is designed as a loyalty program (or contest where permitted), in a way to generate a competition between the users to obtain a benefit and at the same time increase in an exponential way the users or the information.

A name and a platform was created: Tweet My Contest™ (a trademark of Creativos practicos SA de CV). This is an online platform created for integrative accounts that want to use a loyalty program based on making different loyalty programs (or contests where permitted) through their accounts. This platform is also available for any user who wants to use the service.

As a way of example, the loyalty programs (or contests where permitted) are for giving away a prize to one or more users who participate in the loyalty program (or contest where permitted). In one example, the person/company desiring to sponsor the loyalty program (or contest where permitted) can choose among five different types:
1. Number of users that follow the account.
2. Number of users that share a specific tweet.
3. Number of users that share or mention a tweet.
4. Number of users that share a tweet and follow the account.
5. Number of users that share or mention a tweet and follow the account.

Once the sponsor has picked the type of loyalty program (or contest where permitted), the system gives the user multiple customization options. As a way of example, some customization options include:
1. Can previous winners win again?
2. Should the loyalty program (or contest where permitted) begin immediately or at some time in the future?
3. If the loyalty program (or contest where permitted) will span multiple days, should the loyalty program (or contest where permitted) be re-promoted automatically and periodically to generate more participation and follower growth?
4. For the tweet or post that is the focus of the loyalty program (or contest where permitted), will it be custom or begin with a template already in the system (e.g. could be a prepopulated template, a previous loyalty program (or contest where permitted) of the same sponsor, and/or a previous loyalty program (or contest where permitted) from a different sponsor)?
5. Should the winner be publicly identified? If so, the message announcing the winner may be created either by template or totally customized.
6. Define criteria for users that will have access to the loyalty program (or contest where permitted) (e.g. only users that already follow the sponsor, only users that do not follow the sponsor, anyone, users who read a publication, users who read a posting, etc.).

As soon as the loyalty program (or contest where permitted) customization rules have been stated, a summary screen permits the sponsor to review, edit, and approve the loyalty program (or contest where permitted). In one embodiment, the sponsor's loyalty programs (or contests where permitted) are presented in lists of active and deactivated in which the users can manipulate the loyalty programs (or contests where permitted) (e.g. launch loyalty program (or contest where permitted), select winner, close the loyalty program (or contest where permitted), re-run loyalty program (or contest where permitted), make similar loyalty program (or contest where permitted), etc.).

Blacklist

The sponsor can also use the Blacklist, which is where the sponsor places all the accounts that for any reason should be blocked from participating in the loyalty program (or contest where permitted), even though they would otherwise match the characteristics of participating in the loyalty program (or contest where permitted).

Reports

The system could also provide the sponsor the option of generating multiple types of reports. For example, the reports could provide information regarding the reach and/or success of the particular loyalty program (or contest where permitted) in one or more segmented area (similar to that described above in classifying different posts into groups for reposting/republishing). A few examples of some possible reports appear below:

Report #1: Specific Loyalty Program (or Contest where Permitted)
1. Number of users who participated.
2. Growth of the account.
3. General demographic and loyalty program (or contest where permitted) specific information: account that made the loyalty program (or contest where permitted), date of creation, beginning and ending loyalty program (or contest where permitted) hours, message used, winners, etc.

Report #2: Loyalty Program (or Contest where Permitted) Comparison

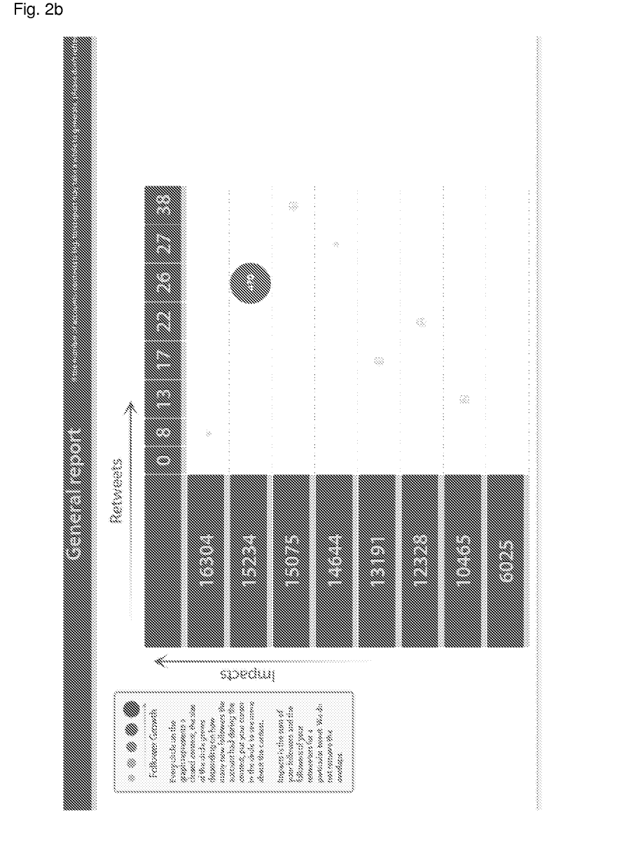

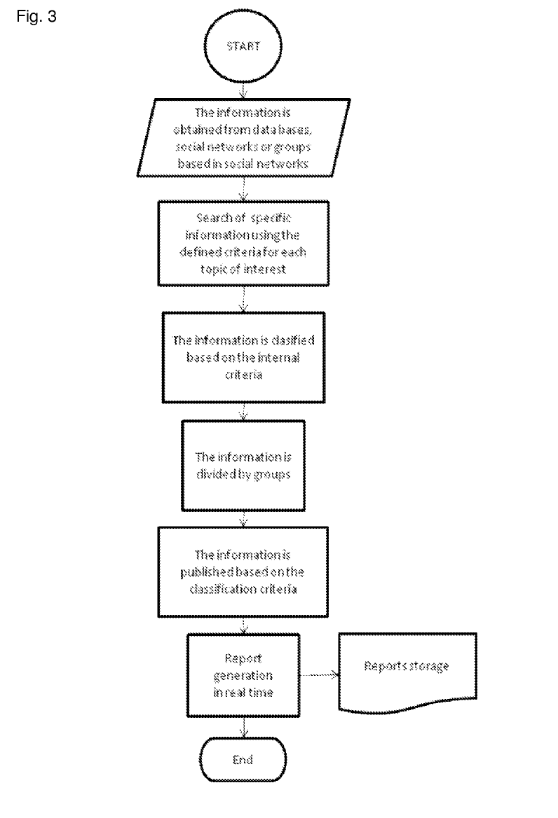

This report compares two or more different loyalty programs (or contests where permitted) so the sponsor can compare which loyalty program (or contest where permitted) was more successful (e.g. impacts, retweets, increased followers, generated sales, etc.). Referring now to FIG. 2b, which depicts in a graphical manner both the impressions and retweets for a particular loyalty program (or contest where permitted). The ball or bar is located at a specific point depending on the number of impressions (sum of all the followers of the account and the account that participated and the quantity of retweets from the people who participated). The color and size of the bar or ball presented could depend on how many new followers the account acquired during the loyalty program (or contest where permitted).

Report #3: Participation

This report could display the number of people who participated in one or more loyalty programs (or contests where permitted) and provide classification information.

As alluded to earlier, it is important to note that the system can also classify and segment the loyalty programs (or contests where permitted) to evaluate and group the more popular loyalty programs (or contests where permitted) from the less popular loyalty programs (or contests where permitted). In one embodiment, the more popular loyalty programs (or contests where permitted) could be republished more often (similar to the grouping system described previously).

Although described throughout in many examples with reference to tweets the disclosed subject matter is equally useful for other social and traditional networks (e.g. Facebook®, MySpace®, Linkedln® (a registered trademark of Linkedln Corporation), Goggle+ (a registered trademark of Google, Inc.), the web, etc.).

Furthermore, the examples provided herein are not to be considered or interpreted as limiting and there is no requirement that any particular embodiment contain all or any particular combination of the elements disclosed herein. Additionally, although described throughout with respect to Twitter®, this is merely by example. The disclosed subject matter could be implemented on any number of social networks, private networks, public networks, the web, the Internet, etc. Also, although described with reference to RSS feeds, the disclosed subject matter could be implemented in other alternative ways and the same is intended to be included herein. As such, the disclosed subject matter should be given the broadest interpretation and those with skill in the art, in combination with this disclosure, could implement the disclosed subject matter in other areas and ways and still remain within the intent of this disclosure.

What is claimed is:

1. A computer implemented method for information retrieval, identification, and dissemination, the method comprising the steps of:
receiving a topic via a communications medium;
searching and identifying information relating to said topic in one or more sources, said information made of a plurality of pieces of information, each piece of information having an associate original author, and wherein said sources include one or more of:
world wide web;
social media;
other information networks, wherein said other information networks may be private networks;
classifying and prioritizing said identified information based on one or more criteria via a processor;
eliminating at least one piece of information based on said classification and said prioritization via a processor;
integrating said remaining classified and prioritized information into one or more electronic communications medium;
packaging at least a portion of said classified and prioritized information into a package of information;
presenting said package of information to one or more users via electronic media, said presenting completed in real-time or near-real-time.

2. The method of claim 1, additionally comprising the step of receiving a geographic area from said user, said geographic area related to said user's geographic location or a geographic location said user is interested in.

3. The method of claim 1, additionally comprising the step of weighting each of said pieces of information, said weighting correlating with how often each piece of information is re-presented.

4. The method of claim 1, additionally comprising the step of weighting each of said pieces of information, said weighting correlating with one or more types of information.

5. The method of claim 1, additionally comprising the step of weighting each of said pieces of information, said weighting correlating with the frequency each piece of information appears within said identified information.

6. The method of claim 1, additionally comprising the step of weighting each of said pieces of information, said weighting correlating with the frequency each piece of information is posted by one or more third parties.

7. The method of claim 1, additionally comprising the step of weighting each of said pieces of information, said weighting correlating with the frequency each piece of information is shared by one or more third parties.

8. The method of claim 1, additionally comprising the step of weighting each of said pieces of information, said weighting correlating with the frequency each piece of information is interacted with by one or more third parties.

9. The method of claim 1, wherein said classification and identification is based on one or more types of information.

10. The method of claim 1, wherein said classification and identification is based on what is being advertised in said piece of information.

11. The method of claim 1, wherein said classification and identification is based on a classification of an advertisement in said piece of information.

12. The method of claim 1, additionally comprising a viral process, wherein said viral process is a loyalty program administered through an online platform, wherein said viral process increases awareness of one or more of said pieces of information, wherein said loyalty program is based on interacting with said one or more of said pieces of information.

13. The method of claim 12, wherein said online platform has a blacklist, said blacklist containing a listing of users that are not allowed to participate in said loyalty program.

14. The method of claim 12, wherein said online platform has reporting functionality including at least:
a specific loyalty program report;
a loyalty program comparison report; and
a participation report.

15. The method of claim 13, said specific loyalty program report comprising:
number of said users that participated in said loyalty program;
increase in number of said users who subscribe or access to said one or more electronic communication mediums; and
demographic information, said demographic information relating to said loyalty program.

16. The method of claim 13, said loyalty program comparison report comparing at least two of said loyalty programs in a graphical manner and including at least a number of times said piece of information was interacted with and the number of times said users viewed said loyalty program.

17. The method of claim 13, said participation report including at least the number of participants or participant demographic information.

18. The method of claim 12, wherein said information is one or more tweets.

19. The method of claim 12, wherein awareness is one or more of the following:
increase the number of said users that subscribe or access said one or more electronic communications mediums; and
increase the number of said users that interact with said piece of information.

20. The method of claim 12, wherein said loyalty program may be customized by a sponsor, said customization including one or more of:
whether previous winners are allowed to win again;
time to start the loyalty program;
time period that the loyalty program will run; and
defining criteria to identify which of said users may participate.
